(19) United States
(12) Patent Application Publication
(10) Pub. No.: US 2021/0114498 A1
(43) Pub. Date: Apr. 22, 2021

(54) FOLDAWAY SHELVING

(71) Applicant: Ranger Design, Montreal (CA)

(72) Inventors: Gary Beere, Montreal (CA); Nacim Mesbah, Montreal (CA)

(21) Appl. No.: 17/073,155

(22) Filed: Oct. 16, 2020

Related U.S. Application Data
(60) Provisional application No. 62/916,721, filed on Oct. 17, 2019.

(51) Int. Cl. B60N 3/00; E05F 5/02

(52) U.S. Cl. CPC B60N 3/002; E05Y 2900/53; E05Y 2900/20; E05F 5/022

(57) ABSTRACT

A foldaway shelving unit for attachment within a vehicle comprises at least one shelf spaced from a floor of the vehicle for supporting a load on the at least one shelf in a foldout position of the foldaway shelving unit. At least one support extends between a first end adjacent the floor to a second end spaced above the floor. A connection member extends between the at least one support and the at least one shelf to connect the at least one shelf to the at least one support. The at least one shelf is moveable between the foldout position and a stored position with the at least one shelf extending upwardly from the connection member. The at least one shelf is disposed above the second end in the foldout position and in the stored position.

### CROSS-REFERENCE TO RELATED APPLICATIONS

This application claims the benefit of U.S. Provisional Application Patent Ser. No. 62/916,721, filed on Oct. 17, 2019, the entire disclosure of which is hereby incorporated herein by reference in its entirety.

### BACKGROUND OF THE INVENTION

### 1. Field of the Invention

The present invention generally relates to foldaway shelving.

### 2. Description of the Prior Art

Foldaway shelving is generally known in the art for providing a space-saving storage options attached to a structure, such as a building or a vehicle. Typically, the shelving includes a shelf spaced above the ground or floor and supported by upright posts. The shelf has a pivotable connection to the upright posts that allows the shelf to move between a foldout position and a stored position. The upright posts of conventional foldaway shelving extend beyond the height of the pivotable connection of the shelf and connect to the structure above the shelf to support the foldaway shelving. The part of the upright posts that extend beyond the pivotable connection takes up space and interferes with packages stored on the shelf. Thus, there is a demand for robust foldaway shelving that obviates the need for this obstruction.

### SUMMARY OF THE INVENTION

The present invention provides foldaway shelving that has improved storage space and reduced obstruction when loading the foldaway shelving. The present invention also provides a low-profile frame with dynamic load conversion. Further, the present invention provides for improving the integrity of a vehicle structure.

It is one aspect of the present invention to provide a foldaway shelving unit for attachment within a vehicle. The foldaway shelving unit comprises at least one shelf spaced from a floor of the vehicle for supporting a load on the at least one shelf in a foldout position of the foldaway shelving unit. At least one support extends between a first end adjacent the floor to a second end spaced above the floor. A connection member extends between the at least one support and the at least one shelf to connect the at least one shelf to the at least one support. The at least one shelf is moveable between the foldout position and a stored position with the at least one shelf extending upwardly from the connection member. The at least one shelf is disposed above the second end in the foldout position and in the stored position.

It is another aspect of the present invention to provide a foldaway shelving unit for attachment within a vehicle. The foldaway shelving unit comprises at least one shelf spaced from a floor of the vehicle for supporting a load on the at least one shelf in a foldout position of the foldaway shelving unit. At least one support extends between a first end adjacent the floor to a second end spaced above the floor. A connection member extends between the at least one support and the at least one shelf to connect the at least one shelf to the at least one support. The at least one shelf is disposed above the second end in the foldout position. A foot extends outwardly from the first end along the floor to a foot end for attaching the foldaway shelving unit to the floor. The foot end is laterally spaced from the at least one support by a first distance. A center of gravity of the at least one shelf in the foldout position is laterally spaced from the at least one support by a second distance. The first distance is greater than the second distance.

It is another aspect of the present invention to provide a foldaway shelving unit. The foldaway shelving unit comprises a shelf spaced above a floor for supporting a load on the shelf in a foldout position of the foldaway shelving unit. A support extends between a first end adjacent the floor to a second end spaced above the floor. A connection member extends between the support and the shelf to connect the shelf to the support. The shelf is disposed above the second end in the foldout position. A foot extends outwardly from the first end along the floor to a foot end for attaching the foldaway shelving unit to the floor. The foot end is laterally spaced from the support by a first distance. A center of gravity of the shelf in the foldout position is laterally spaced from the support by a second distance. The first distance is greater than the second distance. The shelf is moveable between the foldout position and a stored position with the shelf extending upwardly from the connection member.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1A is a side view of the foldaway shelving unit of the present invention in a stored position;

FIG. 1B is a side view of the foldaway shelving unit of the present invention in a foldout position;

FIG. 2 is a perspective view of a number of the foldaway shelving units of the present invention mounted together;

FIG. 3 is a side view of the foldaway shelving unit of the present invention in the stored position; and

FIG. 4 is a cutaway side view of a bracket of the present invention.

### DESCRIPTION OF THE ENABLING EMBODIMENT

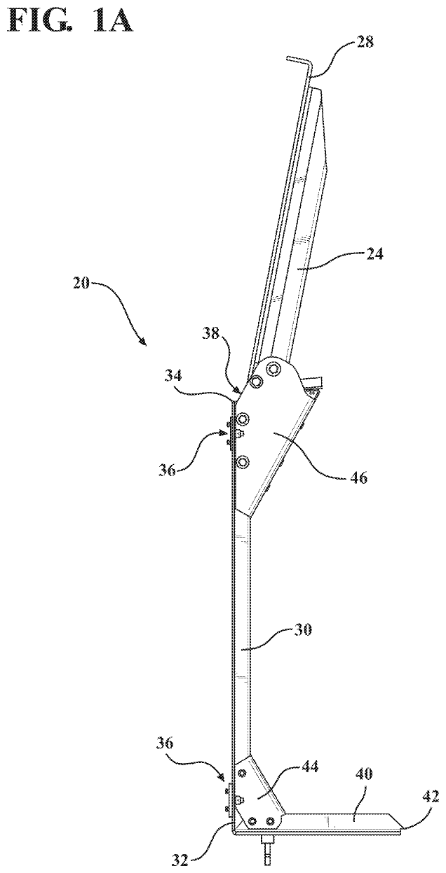

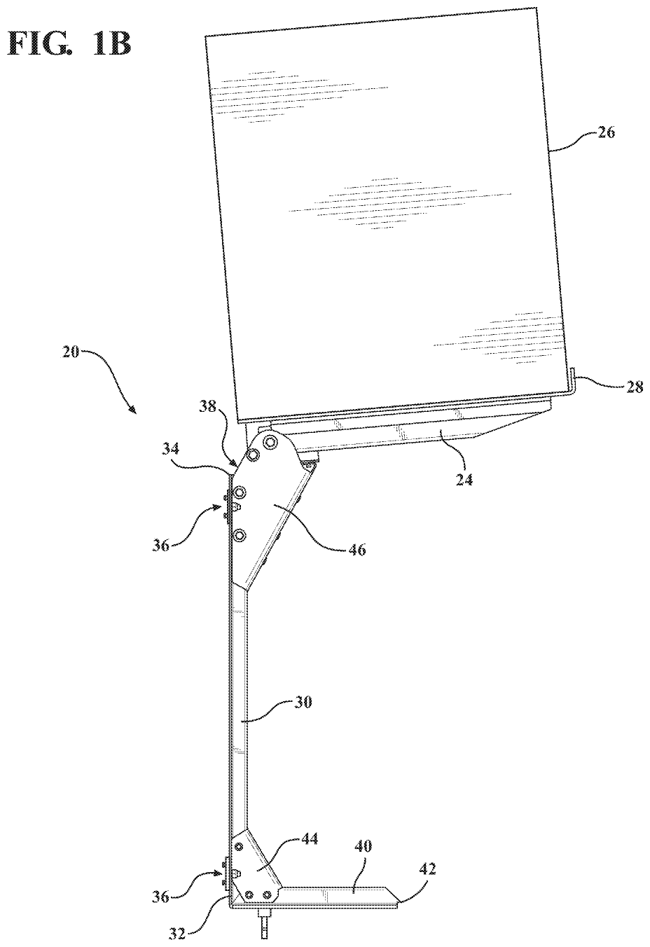

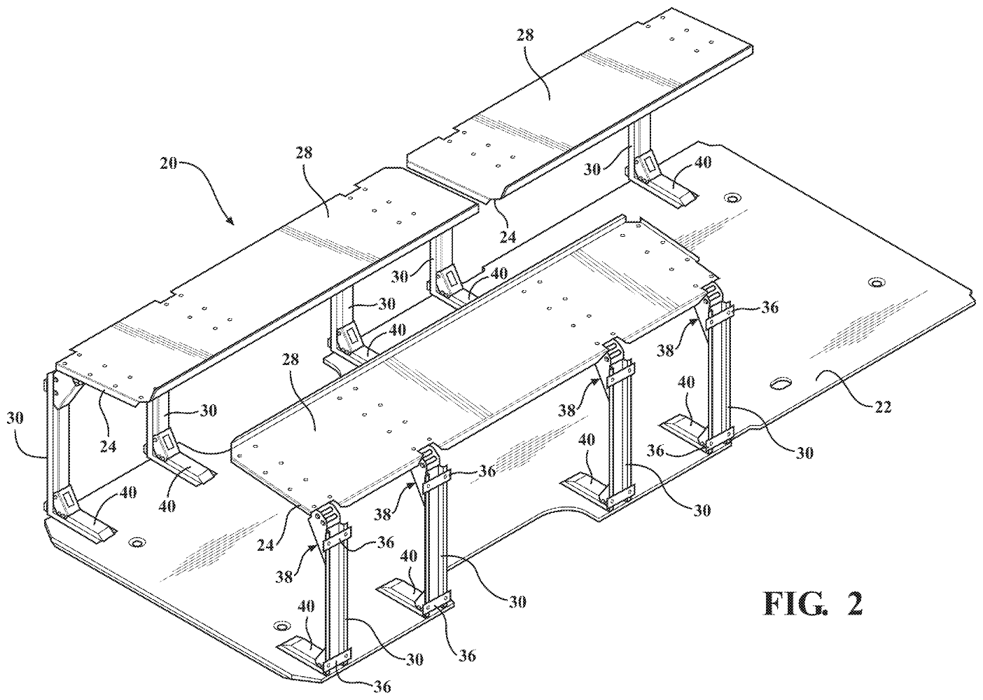

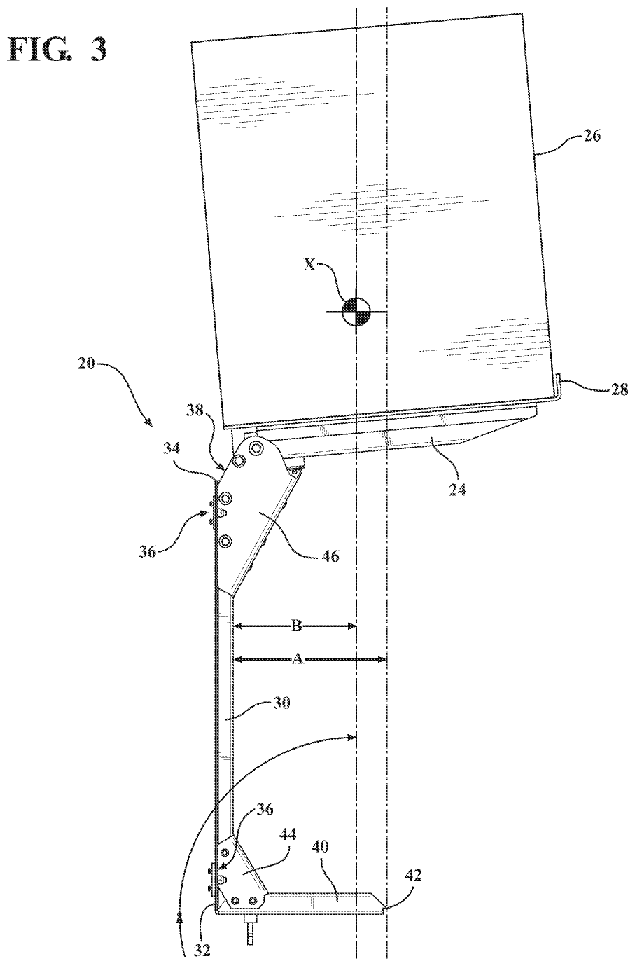

Referring to the Figures, wherein like numerals indicate corresponding parts throughout the several views, foldaway shelving constructed in accordance with one embodiment of the present invention is generally shown in FIGS. 1-3.

With reference to FIGS. 1-3, the foldaway shelving of the present invention may be a foldaway shelving unit 20, generally shown at, for attachment within a vehicle. The foldaway shelving unit 20 may attach to a side of the vehicle and a floor 22 of the vehicle. The foldaway shelving unit 20 includes at least one shelf 24 spaced from the floor 22 of the vehicle for supporting a load 26 on the at least one shelf 24 in a foldout position of the foldaway shelving unit 20. The at least one shelf 24 tray 28 may fold down to define the foldout position for supporting the load 26 (e.g., packages), and up to define a stored position. In other words, the at least one shelf 24 is moveable between the foldout position and the stored position. A tray 28 may be mounted to or integral with the at least one shelf 24. In one embodiment, the at least one shelf 24 is a top shelf of a plurality of shelves, and in another embodiment, the at least one shelf 24 is a single shelf. At least one support 30 extends between a first end 32, adjacent to the floor 22, and a second end 34 spaced above the floor 22. The at least one support 30 may be an upright post or a pair of upright posts spaced from one another for supporting the at least one shelf 24. At least one fastener 36 may extend between the side of the vehicle and the at least one support 30 of the foldaway shelving unit 20 to secure the foldaway shelving unit 20 to the vehicle.

A connection member 38 extends between the at least one support 30 and the at least one shelf 24 tray 28 to connect the at least one shelf 24 tray 28 to the at least one support 30. In the stored position, the at least one shelf 24 extends upwardly from the connection member 38. In both the foldout and the stored positions, the at least one shelf 24 is disposed above the second end 34 of the at least one support 30. In this arrangement, the entire length of the at least one shelf 24 may be used for receiving or loading large packages and the like to form an unobstructed shelf tray.

A foot 40 is connected to the at least one support 30 and extends outwardly from the first end 32 along the floor 22 to a foot end 42 for attaching the foldable shelving unit to the floor 22. The foot end 42 is laterally spaced from the at least one support 30 by a first distance A. In the foldout position, a center of gravity X of the at least one shelf 24 is laterally spaced from the at least one support 30 by a second distance B. The first distance A may be greater than the second distance B. In some embodiments, when a load 26 is on the at least one shelf 24, the center of gravity X of the loaded shelf 24 relative to the position of the foot end 42 allows transfer of the static load to the vehicle floor 22. In addition, the center of gravity X of the loaded shelf 24 relative to the position of the foot end 42 also may also convert dynamic load on the at least one fastener 36 to a shear load 26 adjacent a lower portion of the side. In other words, the foot 40 may be a low profile foot 40 which extends past the center of gravity X of the loaded shelf 24 in order to transfer the static load to the vehicle floor 22 and convert the dynamic load on the lower wall fasteners 36 from a tension load 26 to a shear load 26. It should be appreciated that the foot 40 may be low-profile and may be a cantilever foot 40. Each of the at least one support 30 may have an associated cantilever foot 40.

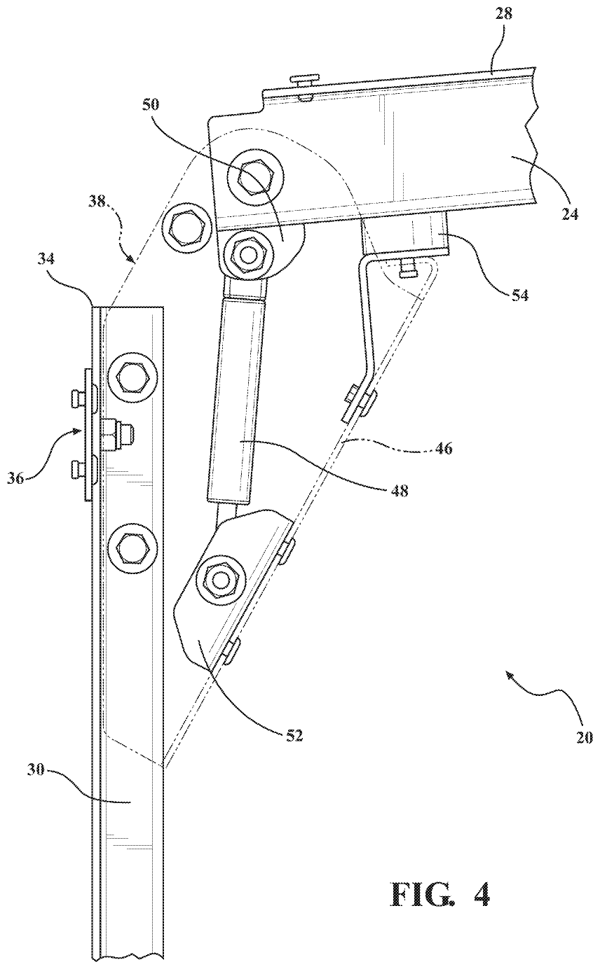

A pair of brackets 44, 46 connect several parts of the foldaway shelving unit 20 together. A first bracket 44 extends between the foot 40 and the at least one support 30 for added strength. With reference to FIG. 4, the connecting member includes a second bracket 46 fixedly secured to the at least one support 30 and the at least one shelf 24. A gas shock, or damper 48, extends between the at least one support 30 and the at least one shelf 24 to dampen movement of the at least one shelf 24 between the foldout position and the stored position. The damper 48 is mounted by a first connector 50 and a second connector 52 on the at least one shelf 24 and the second bracket 46, respectively. In this arrangement, the damper 48 is pivotable about an axis extending through the second connector 52. A bumper 54 stop is provided to stop downward movement of the at least one shelf 24. The second bracket 46 conceals the damper 48 is concealed within the bracket. In particular, the bracket conceals the damper 48 from a side view of the foldaway shelving unit 20.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims.

What is claimed is:

1. A foldaway shelving unit for attachment within a vehicle, said foldaway shelving unit comprising:
at least one shelf spaced from a floor of said vehicle for supporting a load on said at least one shelf in a foldout position of said foldaway shelving unit;
at least one support extending between a first end adjacent said floor to a second end spaced above said floor;
a connection member extending between said at least one support and said at least one shelf to connect said at least one shelf to said at least one support;
said at least one shelf being moveable between said foldout position and a stored position with said at least one shelf extending upwardly from said connection member; and
wherein said at least one shelf is disposed above said second end in said foldout position and in said stored position.

2. The foldaway shelving unit according to claim 1 further including a foot extending outwardly from said first end along said floor to a foot end for attaching said foldaway shelving unit to said floor.

3. The foldaway shelving unit according to claim 2, wherein said foot end is laterally spaced from said at least one support by a first distance and wherein a center of gravity of said at least one shelf in said foldout position is laterally spaced from said at least one support by a second distance, whereby said first distance is greater than said second distance.

4. The foldaway shelving unit according to claim 1 further including at least one fastener extending between a side of said vehicle and said foldaway shelving unit to secure said foldaway shelving unit to said vehicle, whereby said at least one fastener experiences a shear load in said foldout position.

5. The foldaway shelving unit according to claim 1 further including a damper extending between said at least one support and said at least one shelf to dampen movement of said at least one shelf between said foldout position and said stored position.

6. The foldaway shelving unit according to claim 5, wherein said connection member includes a bracket fixedly secured to said at least one support and said at least one shelf to conceal said damper from a side view of said foldaway shelving unit.

7. The foldaway shelving unit according to claim 6, wherein said damper is mounted by a first connector and a second connector on said at least one shelf and said bracket, respectively.

8. The foldaway shelving unit according to claim 1, wherein said at least one support is a pair of upright posts spaced from one another, and wherein said at least one shelf is a top shelf of a plurality of shelves.

9. A foldaway shelving unit for attachment within a vehicle, said foldaway shelving unit comprising:
at least one shelf spaced from a floor of said vehicle for supporting a load on said at least one shelf in a foldout position of said foldaway shelving unit;
at least one support extending between a first end adjacent said floor to a second end spaced above said floor;
a connection member extending between said at least one support and said at least one shelf to connect said at least one shelf to said at least one support;
wherein said at least one shelf is disposed above said second end in said foldout position;
a foot extending outwardly from said first end along said floor to a foot end for attaching said foldaway shelving unit to said floor;
said foot end being laterally spaced from said at least one support by a first distance; and
a center of gravity of said at least one shelf in said foldout position being laterally spaced from said at least one support by a second distance, whereby said first distance is greater than said second distance.

10. The foldaway shelving unit according to claim 9, whereby said at least one shelf is moveable between said foldout position and a stored position with said at least one shelf extending upwardly from said connection member.

11. The foldaway shelving unit according to claim 9 further including at least one fastener extending between a side of said vehicle and said foldaway shelving unit to secure said foldaway shelving unit to said vehicle, whereby said at least one fastener experience a shear load in said foldout position.

12. The foldaway shelving unit according to claim 10 further including a damper extending between said at least one support and said at least one shelf to dampen movement of said at least one shelf between said foldout position and said stored position.

13. The foldaway shelving unit according to claim 11, wherein said connection member includes a bracket fixedly secured to said at least one support and said at least one shelf to conceal said damper from a side view of said foldaway shelving unit.

14. The foldaway shelving unit according to claim 9, wherein said damper is mounted by a first connector and a second connector on said at least one shelf and said bracket, respectively.

15. The foldaway shelving unit according to claim 9, wherein said at least one support is a pair of upright posts spaced from one another, and wherein said at least one shelf is a top shelf of a plurality of shelves.

16. A foldaway shelving unit comprising:
a shelf spaced above a floor for supporting a load on said shelf in a foldout position of said foldaway shelving unit;
a support extending between a first end adjacent said floor to a second end spaced above said floor;
a connection member extending between said support and said shelf to connect said shelf to said support;
said shelf being disposed above said second end in said foldout position;
a foot extending outwardly from said first end along said floor to a foot end for attaching said foldaway shelving unit to said floor, wherein said foot end is laterally spaced from said support by a first distance;
a center of gravity of said shelf in said foldout position being laterally spaced from said support by a second distance, whereby said first distance is greater than said second distance; and
said shelf being moveable between said foldout position and a stored position with said shelf extending upwardly from said connection member.

17. The foldaway shelving unit according to claim 16 further including a damper extending between said support and said shelf to dampen movement of said shelf between said foldout position and said stored position.

18. The foldaway shelving unit according to claim 17, wherein said connection member includes a bracket fixedly secured to said support and said shelf to conceal said damper from a side view of said foldaway shelving unit.

19. The foldaway shelving unit according to claim 18, wherein said damper is mounted by a first connector and a second connector on said shelf and said bracket, respectively.

20. The foldaway shelving unit according to claim 16, wherein said support is a pair of upright posts spaced from one another, and wherein said shelf is a top shelf.
